(19) United States
(12) Patent Application Publication
(10) Pub. No.: US 2009/0231602 A1
(43) Pub. Date: Sep. 17, 2009

(54) Image processing apparatus, image forming apparatus, and image processing method

(75) Inventor: Seiichiro Oku, Kanagawa (JP)

Correspondence Address: AKERMAN SENTERFITT, 8100 BOONE BOULEVARD, SUITE 700, VIENNA, VA, 22182-2683, US

(73) Assignee: FUJIFILM CORPORATION, Tokyo (JP)

(21) Appl. No.: 12/379,895

(22) Filed: Mar. 4, 2009

(30) Foreign Application Priority Data
Mar. 14, 2008 (JP) 2008-066336

(51) Int. Cl. G06K 15/10

(52) U.S. Cl. 358/1.8

(57) ABSTRACT

An image processing apparatus that includes a storage component, sending components, receiving components, driving components, a detecting component and a sending control component is provided. The driving components are provided to correspond to each of the receiving components and each of the image forming components. Each driving component drives the corresponding image forming component based on divided image information received by the receiving component. The detecting component detects displacement between a position of recording medium and the areas formed by the image forming components. The sending control component controls so that the divided image information of an amount of information defined in accordance to the displacement detected by the detecting component is sent from the driving component corresponding to the image forming component of one of adjacent areas to the driving component corresponding to the other image forming component.

### CROSS-REFERENCE TO RELATED APPLICATION

This application claims priority under 35 USC 119 from Japanese Patent Application No. 2008-066336, the disclosure of which is incorporated by reference herein.

### BACKGROUND OF THE INVENTION

1. Field of the Invention

The present invention relates to an image processing apparatus, an image forming apparatus, and an image processing method and particularly to an image processing apparatus suitable for image forming and processing of a line type as a scanning type, an image forming apparatus having the image processing apparatus, and an image processing method.

2. Description of the Related Art

As a structure of an ink-jet head for carrying out higher-density drawing, there is a matrix-type head in which nozzles are arranged two-dimensionally. In this matrix-type head, spaces of pixels may be made shorter than length and width required for each nozzle. As a result, 600 dpi or higher-density drawing may be accomplished. In this way, high-resolution and high-quality image forming may be expected.

As the scanning type of the ink-jet head, there are a shuttle scan type for causing the head to scan a printing medium in a reciprocating manner and a line type having a fixed head equals in width to a printing medium and causing the head to scan the printing medium to thereby carry out image forming. Higher-speed image forming may be achieved with the line type than with the shuttle type.

Although a high-resolution image may be formed at extremely high speed with the above-described matrix-type head has the line-type structure, it is necessary to transmit a large amount of printing data to the head at high speed. Specifically, if the line head of 1200 dpi and 500 mm wide is driven at jet frequency of 40 KHz, for example, the data amounts to about 1,000,000,000 pixels/second. In a case of 2 bits/pixel (4 shades of gray/pixel), at least 2 Gbits/sec transmission rate is required.

Therefore, it is desirable, in terms of cost and reliability, to transmit the data in a plurality of transmission lines in parallel.

Achievement of such a high transmission rate is hampered by data readout speed from page memory. Therefore, it is necessary to have page memory capacity of a plurality of pages from which readout processing of a plurality of areas in a width direction is carried out in parallel.

Moreover, a size of the line head in the line type need cover a print width of the medium. Even an A4 width medium, for example, is 200 mm or wider. Therefore, it is difficult to manufacture the line head as an integral structure. Consequently, it is disadvantageous in terms of yield and cost and not preferable to manufacture a long precision structure as an integral structure.

Therefore, preferably, heads about 20 mm to 40 mm are manufactured as units of size of one head and are combined to form a long head.

In this case, the structure is as shown in FIG. 12. FIG. 12 shows the structure in which four head modules are combined. As shown in the drawing, this printer system includes a host device, a page memory, a readout control unit, data sending units, data receiving units, head module drive control units, and head modules.

The host device instructs image information for printing and instructs to print image represented by the image information. The page memory stores the image information. The readout control unit reads the image information stored in the page memory to be allocated to the respective four head modules.

Specifically, the readout control unit reads pieces of divided image information indicated by respective four divided images shown in FIG. 13 in order to transmit them to the respective head modules.

As shown in FIG. 12, the pieces of image information read by the readout control unit are sent from the data sending units and received by the data receiving units via the transmission lines which are several meters long in the apparatus having a long line head, i.e., the apparatus for carrying out wide printing.

Head module drive control units drive the head modules based on the received image information and, as a result, the head modules form images.

As described above, as a system for driving the high-density line head at high speed, it is necessary to divide the line head into a plurality of head modules each of which has the transmission line for the image information as shown in FIG. 12 and FIG. 13.

In the structure shown in FIG. 12, however, there are the following problems. First, in general, there are errors in mounting positions of the head modules. Although displacement in a medium conveying direction (sub-scanning direction) may be adjusted by delaying jet timing or the like, there is also displacement (registration displacement) in a direction in which the head modules are arranged (main scanning direction), i.e., a width direction of the recording medium.

This registration displacement easily occurs, because the medium is conveyed at high speed. An amount of displacement varies and is not constant during conveyance in many cases.

Because nozzle positions are fixed, the registration displacement may not be corrected by means of timing or the like and a different method is required. Therefore, in a technique disclosed in Japanese Patent Application Laid-Open (JP-A) No. 2006-62118, a printing position is corrected by moving a head. This method requires an actuator for moving the head modules. Since the line head is wider than the medium and heavy, the actuator need be high-power so as to move it at high speed. Besides, moving the head is undesirable, because it causes vibrations.

In JP-A No. 2006-35852, a technique for shifting image data in page memory is disclosed. In JP-A No. 2006-35852, movement processing in a direction of arrangement of heads is carried out in an integrated control unit and then the image data is transmitted to the heads. In JP-A No. 2005-186475, similar processing is carried out in an image forming control unit.

If these methods are used in the system for carrying out high-density and wide printing, however, an amount of page data to be handled is extremely large and therefore a high-speed processing circuit or the like is necessary to put the methods into practice.

For example, if a page is 1200 dpi., 700 mm wide, 500 mm long, and two bits per pixel, a data amount for a page is 1.6 Gbytes. To print the image at jet speed of 30 KHz, readout and transmission of the image at about 1.6 Gbytes/sec. are required. A practical range of operation speed is 400 MHz to 800 MHz with present semiconductor memory and processing circuit. Considering cost and the like as well, area division or the like becomes necessary.

In this case, the shifting processing involves processing on borders between the areas. If the image data is larger, a structure having page memory capacity of a plurality of pages and a plurality of sending units that operate in parallel should be considered. In this case, however, there may be separate housings, which makes data exchange more difficult.

In a case of a low-speed printer, only the shifting processing of the image data may suffice as in the technique disclosed in JP-A No. 2006-35852. However, in the case of the high-density and wide printer, it is not realistic to simply transfer data for one line from an end to the heads, because data transfer speed becomes extremely high.

There is a yet another possible method as shown in FIG. 14. In the method shown in the drawing, image data for the maximum shift is transferred additionally in transmitting image data to the head module and an only necessary part is printed according to a shifted amount.

In this case, image data larger in size than the image data that is actually necessary need be transferred and higher speed is required of the transmission units. Because the transmission lines are a few meters long in many cases as described above, increase in speed may decrease reliability of the image data.

As described above, the prior-art technique for coping with the displacement in the width direction of the recording medium causes reduction in the transmission speed of the image information.

### SUMMARY OF THE INVENTION

With the above problems in view, it is an object of the present invention to provide an image processing apparatus, an image forming apparatus, and an image processing method capable of coping with displacement in a width direction of a recording medium without reducing transmission speed of image information.

An invention according to a first aspect is an image processing apparatus. The image processing apparatus includes: a storage component that stores image information; sending components provided to correspond to each of a plurality of image forming components to which areas on a recording medium to be formed with an image have been allocated in advance, each sending component sending divided image information indicating an image corresponding to the area from the image information stored in the storage component; receiving components provided to correspond to each of the sending components, each receiving component receiving the divided image information sent by the sending component; driving components provided to correspond to each of the receiving components and each of the image forming components, each driving component driving the corresponding image forming component based on the divided image information received by the receiving component; a detecting component that detects displacement between a position of the recording medium and the areas formed by the image forming components; and a sending control component that controls so that the divided image information of an amount of information defined in accordance to the displacement detected by the detecting component is sent from the driving component corresponding to the image forming component of one of adjacent areas to the driving component corresponding to the other image forming component.

An invention according to a second aspect is an image forming apparatus. The image forming apparatus includes: an image processing apparatus; and image forming components, wherein the image processing apparatus includes: a storage component that stores image information; sending components provided to correspond to each of the plurality of image forming components to which areas on a recording medium to be formed with an image have been allocated in advance, each sending component sending divided image information indicating an image corresponding to the area from the image information stored in the storage component; receiving components provided to correspond to each of the sending components, each receiving component receiving the divided image information sent by the sending component; driving components provided to correspond to each of the receiving components and each of the image forming components, each driving component driving the corresponding image forming component based on the divided image information received by the receiving component; a detecting component that detects displacement between a position of the recording medium and the areas formed by the image forming components; and a sending control component that controls so that the divided image information of an amount of information defined in accordance to the displacement detected by the detecting component is sent from the driving component corresponding to the image forming component of one of adjacent areas to the driving component corresponding to the other image forming component.

An invention according to a third aspect is an image processing method. The image processing method includes: (a) sending, by sending components provided to correspond to each of a plurality of image forming components to which areas on a recording medium to be formed with an image have been allocated in advance, divided image information indicating an image corresponding to the area from image information stored in a storage component that stores the image information; (b) receiving the divided image information sent in (a) by receiving components provided to correspond to each of the sending components; (c) detecting displacement between a position of the recording medium and the areas formed by the image forming components; (d) controlling so that the divided image information of an amount of information defined in accordance to the displacement detected in (c) is sent from the driving component corresponding to the image forming component of one of adjacent areas to the driving component corresponding to the other image forming component; and (e) driving the corresponding image forming component by the driving component based on the divided image information received by the receiving component and the divided image information sent in (d).

### BRIEF DESCRIPTION OF THE DRAWINGS

FIG. 1 is an example of a general block diagram of an ink-jet recording apparatus according to an exemplary embodiment.

FIG. 2 is a plan view of an essential portion around a printing portion of the ink-jet recording apparatus.

FIG. 3 is a plan perspective view showing an example of a structure of a head.

FIG. 4 is an enlarged view of a portion of the example of the structure of the head.

FIG. 5 is a sectional view showing a three-dimensional structure of a droplet jet element.

FIG. 6 is a drawing showing arrangement of nozzles of the head.

FIG. 7 is a block diagram showing an example of a system configuration of the ink-jet recording apparatus.

FIG. 8 is a drawing showing details of structures related to the exemplary embodiment out of the structures of the ink-jet recording apparatus.

FIG. 9 is a drawing showing details of a head module drive control portion.

FIG. 10 is a drawing showing a specific example in which pieces of divided image information of amounts determined by displacement are sent from inter-module transmitting units.

FIG. 11 is a flowchart showing overall processing performed in the ink-jet recording apparatus including image information sending processing.

FIG. 12 is a drawing showing a structure in a related art.

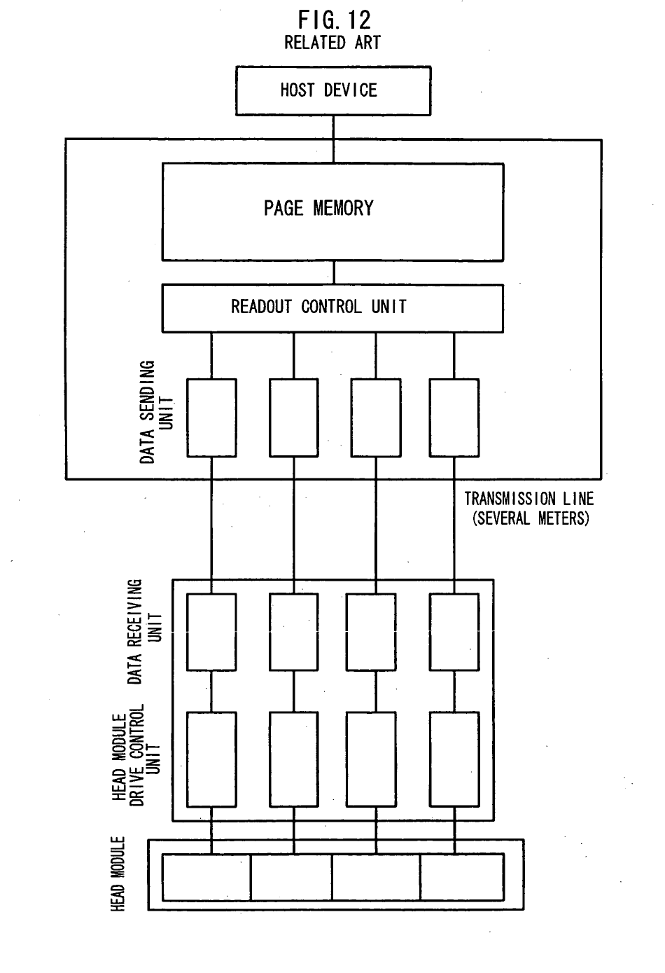

FIG. 13 is a drawing showing divided image information divided into four pieces.

FIG. 14 is a drawing showing divided image information when image information for the maximum shift is transferred additionally.

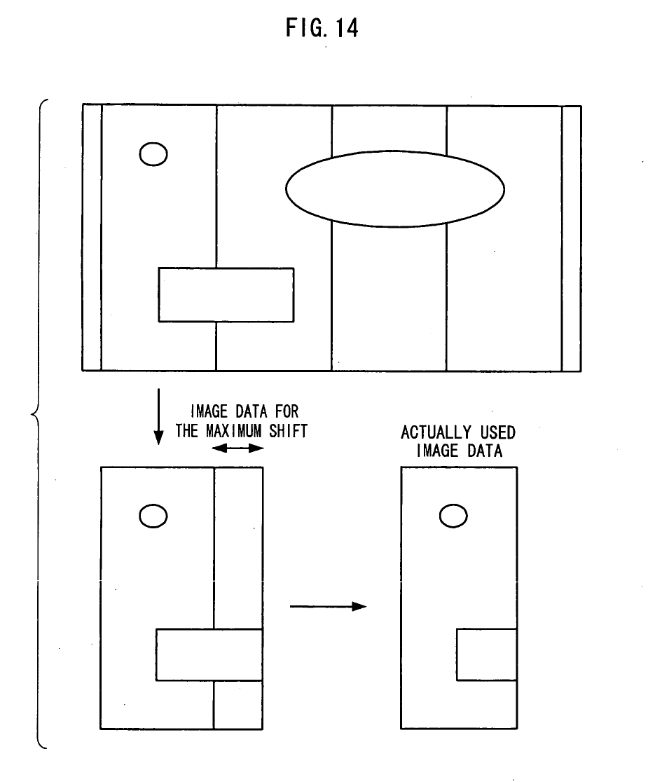

### DETAILED DESCRIPTION OF THE INVENTION

An exemplary embodiment of the present invention will be described below in detail with reference to the drawings.

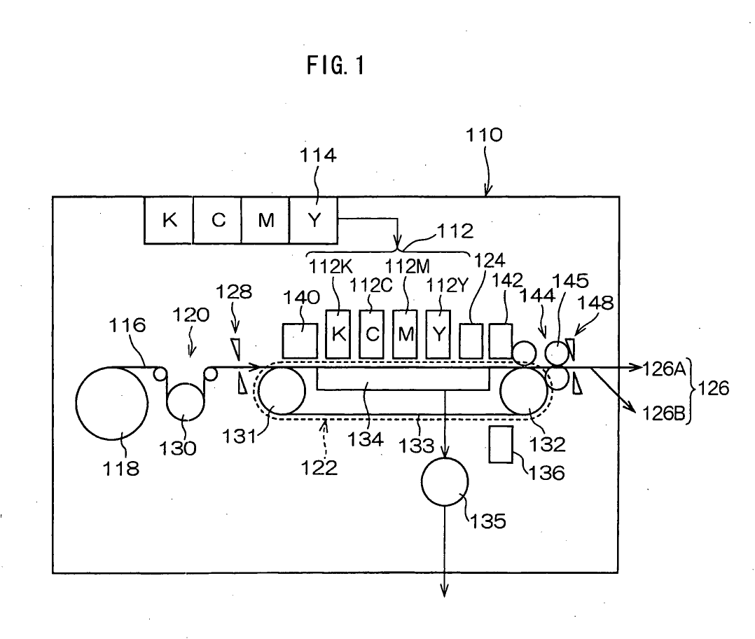

FIG. 1 is a general block diagram of an ink-jet recording apparatus and showing the exemplary embodiment of an image forming apparatus according to the invention. As shown in the drawing, the ink-jet recording apparatus 110 includes a printing portion 112 having a plurality of ink-jet recording heads (hereafter referred to as heads) 112K, 112C, 112M, and 112Y provided to correspond to respective inks of black (K), cyan (C), magenta (M), and yellow (Y), an ink storage/loading portion 114 for storing ink to be supplied to the respective heads 112K, 112C, 112M, and 112Y, a paper feeding portion 118 for feeding recording paper 116 as a recording medium, a curl removing portion 120 for removing curl of the recording paper 116, a belt conveying portion 122 disposed to face a nozzle face (inkjet face) of the printing portion 112 to convey the recording paper 116 while maintaining flatness of the recording paper 116, a printing detecting portion 124 for reading a result of printing by the printing portion 112, and a paper ejecting portion 126 for ejecting recording paper (printed matter) outside after recording. In the present specification, “printing” includes printing of image as well as printing of letters.

The ink storage/loading portion 114 has ink tanks for storing ink of colors corresponding to the respective heads 112K, 112C, 112M, and 112Y and the respective tanks communicate with the heads 112K, 112C, 112M, and 112Y through ducts. The ink storage/loading portion 114 further includes an informing component for informing that an ink level is low if this is the case and a mechanism for preventing loading of tanks of wrong colors.

Although a magazine for roll paper (continuous paper) is shown as an example of the paper feeding portion 118 in FIG. 1, a plurality of magazines for different paper widths and paper qualities may be provided. Instead of or in addition to the magazine for the roll paper, a cassette in which a stack of cut sheets is loaded may be used to feed paper.

If a plurality of kinds of recording media may be used, bar-codes or information recording bodies such as wireless tags on which pieces of kind information of the media are recorded are attached to the magazines, a predetermined reading device reads the information on the information recording body to thereby automatically identify the kind (media kind) of the recording medium to be used, and ink jet control is carried out to achieve ink jet suitable to the media kind, preferably.

The recording paper 116 sent out from the paper feeding portion 118 retains curl and curls, because it was loaded in the magazine. To remove the curl, in the curl removing portion 120, a heating drum 130 gives heat to the recording paper 116 in an opposite direction to a direction of the curl in the magazine. At this time, it is preferable to control heating temperature so that a print side is slightly curled outward.

In a case of an apparatus structure in which the roll paper is used, a cutter 128 for cutting is provided as shown in FIG. 1 and the cutter 128 cuts the roll paper to desired lengths. If the cut sheets are used, the cutter 128 is unnecessary.

After the curl removal treatment, the recording paper 116 is cut and sent to the belt conveying portion 122. In the belt conveying portion 122, an endless belt 133 is looped over rollers 131, 132.

The belt 133 is wider than the recording paper 116 and is formed on its belt face with a large number of suction holes. As shown in the drawing, an attracting chamber 134 is provided in such a position inside the belt 133 looped over the rollers 131, 132 as to face the nozzle face of the printing portion 112 and a sensor face of the printing detecting portion 124. By sucking the attracting chamber 134 with a fan 135 to form a negative pressure in the chamber 134, the recording paper 116 is attracted and retained onto the belt 133. Electrostatic attraction may replace the suction attraction.

When power of a motor is transmitted to at least one of the rollers 131, 132 over which the belt 133 is looped, the belt 133 is driven clockwise in FIG. 1 and the recording paper 116 retained on the belt 133 is conveyed from left to right in FIG. 1.

Because the ink adheres onto the belt 133 after borderless printing or the like, there is a belt cleaning portion 136 provided in a predetermined position outside the belt 133 (a suitable position outside a printing area). The belt cleaning portion 136 may employ a method of nipping with a brush roll, a water absorption roll, and the like, an air blowing method of blowing clean air, or a combination of them, for example. In the case of the method of nipping with the cleaning roll, great cleaning effect may be obtained by setting belt linear speed and roller linear speed different from each other.

A roller nip conveying mechanism may be employed in place of the belt conveying portion 122. If the printing area is conveyed by roller nipping, however, the image is likely to be blurred, because the roller comes in contact with the print side of paper immediately after printing. Therefore, in the printing area, the attracting belt conveyance without contact with the image surface is preferable.

On an upstream side of the printing portion 112 on a paper conveying path formed of the belt conveying portion 122, a heating fan 140 is provided. The heating fan 140 blows heated air on the recording paper 116 before printing to heat the recording paper 116. If the recording paper 116 is heated immediately before printing, ink dries faster after landing.

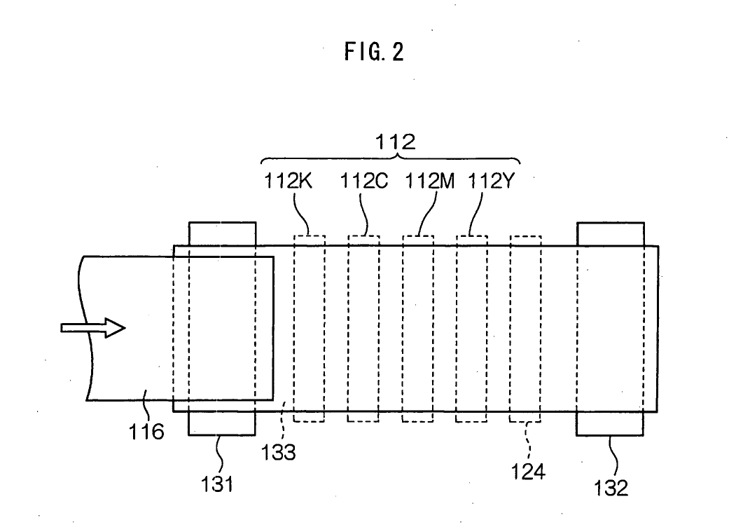

Each of the heads 112K, 112C, 112M, and 112Y of the printing portion 112 has a length corresponding to a maximum sheet width of the recording paper 116 intended for use in the ink-jet recording apparatus 110 and is a full-line head with a nozzle face on which a plurality of nozzles for jetting ink are arranged throughout a length (an entire width of a printable area) more than at least one side of the largest-sized recording paper 116 (see FIG. 2).

The heads 112K (black) (K), 112C (cyan) (C), 112M (magenta) (M), and 112Y (yellow) (Y) are disposed in this order from the upstream side along a feeding direction of the recording paper 116. The respective heads 112K, 112C, 112M, and 112Y are fixed to extend along a direction substantially orthogonal to the conveying direction of the recording paper 116.

By conveying the recording paper 116 with the belt conveying portion 122 while discharging inks of different colors from the respective heads 112K, 112C, 112M, and 112Y, a color image may be formed on the recording paper 116.

As described above, with the structure provided with the full-line heads 112K, 112C, 112M, and 112Y of different colors and having nozzle rows covering the entire sheet width, a full-page image may be recorded on the recording paper 116 with a single operation (i.e., with single sub-scanning) of moving the recording paper 116 and the printing portion 112 with respect to each other in the paper feeding direction (sub-scanning direction). Therefore, printing at higher speed is possible and productivity may be improved as compared with shuttle-type heads in which recording heads reciprocate in a direction orthogonal to a sheet conveying direction.

Although standard colors (four colors), K, C, M, and Y have been described as examples in the exemplary embodiment, a combination of colors of inks and the number of colors is not limited to that in the exemplary embodiment. Light-colored inks, deep-colored inks, inks of custom colors may be added as necessary. For example, ink-jet heads for jetting light-colored ink such as light cyan and light magenta may be added. The order of arrangement of the heads of the respective colors is not especially limited either.

The printing detecting portion 124 shown in FIG. 1 includes an image sensor (a line sensor or an area sensor) for picking up an image of a result of jet by the printing portion 112 and functions as a means of checking jet characteristics such as clogging in the nozzles and landing position errors based on the image of jet read by the image sensor.

Preferably, used as the printing detecting portion 124 in the exemplary embodiment may be a CCD area sensor formed of a two-dimensional array of a plurality of light receiving elements (photoelectric conversion elements) on a light receiving surface. The area sensor has an imaging range covering at least the entire ink discharge width (image recording width) by the respective heads 112K, 112C, 112M, and 112Y. A single area sensor may cover a necessary imaging range or a plurality of area sensors may be combined (pieced together) to cover the necessary imaging range. Alternatively, the area sensor may be supported on a moving mechanism and moved (caused to scan) to take an image of the required imaging range.

A line sensor may be used in place of the area sensor. In this case, the line sensor preferably includes an array of light receiving elements (an array of photoelectric conversion elements) wider than at least the inkjet width (image recording width) by the respective heads 112K, 112C, 112M, and 112Y.

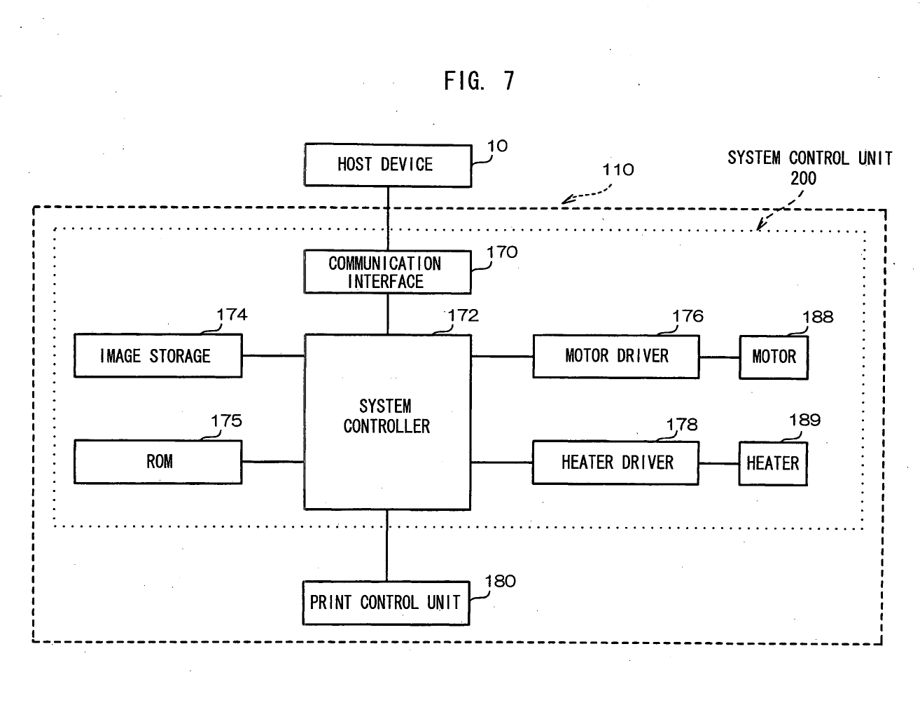

As described above, the printing detecting portion 124 is a block including the image sensor, reads the image printed on the recording paper 116, performs necessary signal processing and the like to detect printing conditions (whether or not discharge was carried out, landing position errors, dot shapes, optical density, and the like), and provides the detection result to a print control unit 180 and a system controller 172 (FIG. 7).

A posterior drying portion 142 is provided in a subsequent stage to the printing detecting portion 124. The posterior drying portion 142 is a means for drying the printed image surface and a heating fan is used for the portion 142, for example. Since it is preferable to avoid contact with the printed surface until the ink dries after printing, blowing heated air is preferable.

In a case of printing on porous paper with dye-based ink, weather resistance of the image may be improved by closing holes in the paper by pressurization to thereby avoid contact with substances such as ozone responsible for breakdown of dye molecules.

A heating/pressurizing portion 144 is provided in a subsequent stage to the posterior drying portion 142. The heating/pressurizing portion 144 is a means for controlling gloss level of the image surface and transfers concave-convex shapes to the image surface by pressurizing the image surface with a pressurizing roller 145 having predetermined concave-convex shapes on its surface while heating the image surface.

The printed matter produced as described above is ejected from the paper ejecting portion 126. Preferably, intended images desired to be printed (printed matters with target images) and test prints are ejected separately. The ink-jet recording apparatus 110 is provided with a separating component for switching a paper ejection path to separate the printed matters with intended images and the printed matters with the test prints and send them to ejecting portions 126A, 126B, respectively.

If the intended image and the test print are formed simultaneously on the same large sheet, a cutter 148 cuts off the test print part. Though it is not shown in the drawing, the ejecting portion 126A for the intended images is provided with a sorter for stacking up images separately for different orders.

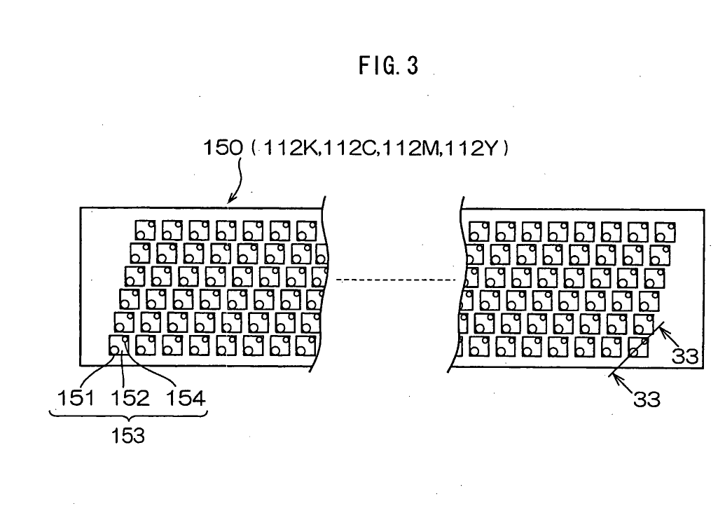

Next, structures of the heads will be described. Because the respective heads 112K, 112C, 112M, and 112Y of different colors have the same structures, a reference numeral 150 will be used below to represent the heads (FIG. 3).

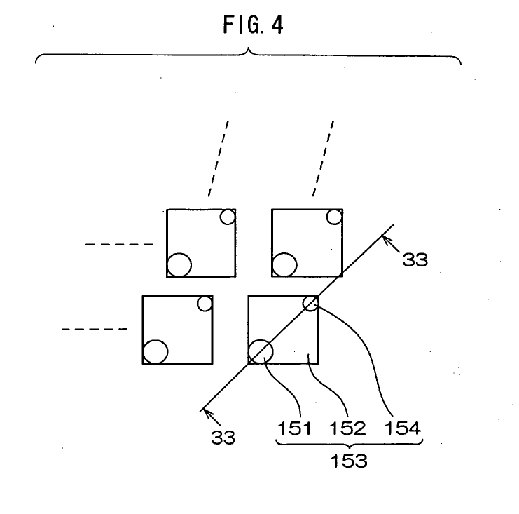

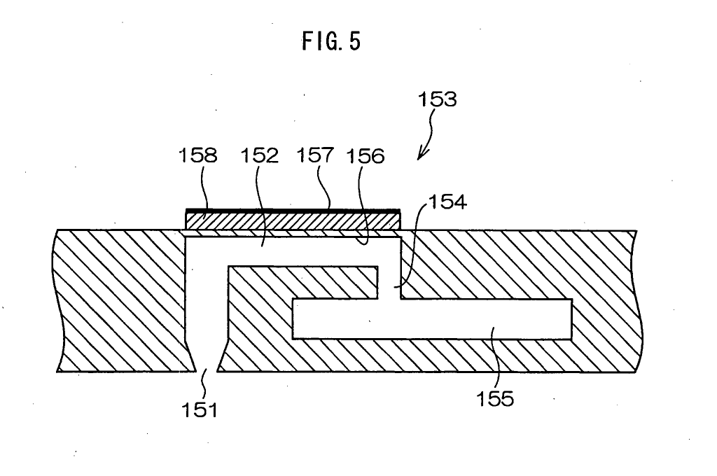

FIG. 3 is a plan perspective view showing an example of the structure of the head 150 and FIG. 4 is an enlarged view of a part of FIG. 3. FIG. 5 is a sectional view (sectional view along a line 33 to 33 in FIG. 4) showing a three-dimensional structure of one droplet discharge element (an ink chamber unit corresponding to one nozzle 151).

To reduce a dot pitch of the print on the recording paper 116, a nozzle pitch in the head 150 need be reduced. The head 150 in the exemplary embodiment has the structure in which the plurality of ink chamber units (droplet jet elements) 153 each formed of the nozzle 151 as an ink jet port, a pressure chamber 152 corresponding to the nozzle 151, and the like are disposed in a staggered matrix (two-dimensional) arrangement as shown in FIG. 3 and FIG. 4. In this way, substantial projected spaces between nozzles (a projected nozzle pitch) arranged along a head longitudinal direction (a direction orthogonal to the paper feeding direction) may be reduced.

The structure in which one or more rows of nozzles are disposed in a direction substantially orthogonal to the feeding direction of the recording paper 116 throughout a length corresponding to the entire width of the recording paper 116 is not restricted to that in the exemplary embodiment.

The pressure chamber 152 provided to correspond to each nozzle 151 has a substantially square planar shape (see FIG. 3 and FIG. 4). An outlet port to the nozzle 151 is provided in one of opposite corner portions on a diagonal line of the pressure chamber 152 and an inlet port (supply port) 154 for supplied ink is provided in the other. The shape of the pressure chamber 152 is not restricted to that in the exemplary embodiment and various planar shapes such as a quadrilateral (a rhombus, a rectangle, or the like), a pentagon, a hexagon, other polygons, a circle, and an ellipse are possible.

As shown in FIG. 5, each pressure chamber 152 communicates with a common flow path 155 through the supply port 154. The common flow path 155 communicates with an ink tank that is an ink supply source. The ink supplied from the ink tank is distributed and supplied to the respective pressure chambers 152 via the common flow path 155.

To a pressure plate (diaphragm used also as a common electrode) 156 forming part of faces (a top face in FIG. 5) of the pressure chamber 152, an actuator 158 having an individual electrode 157 is joined. By applying driving voltage between the individual electrode 157 and the common electrode, the actuator 158 is deformed, a capacity of the pressure chamber 152 changes, and a resultant change of pressure causes the nozzle 151 to discharge the ink. For the actuator 158, a piezoelectric element using a piezoelectric substance such as lead zirconate titanate and barium titanate is used preferably. After the ink jet and when the displaced actuator 158 returns to an original position, the pressure chamber 152 is refilled with new ink flowing from the common flow path 155 through the supply port 154.

By controlling driving of the actuator 158 corresponding to each nozzle 151 according to dot arrangement data generated from image information, an ink droplet may be jetted from the nozzle 151. As described in FIG. 1, by conveying the recording paper 116 as the recording medium at constant speed in the sub-scanning direction while controlling the ink jet timing of each nozzle 151 according to a conveying speed, a desired image may be recorded on the recording paper 116.

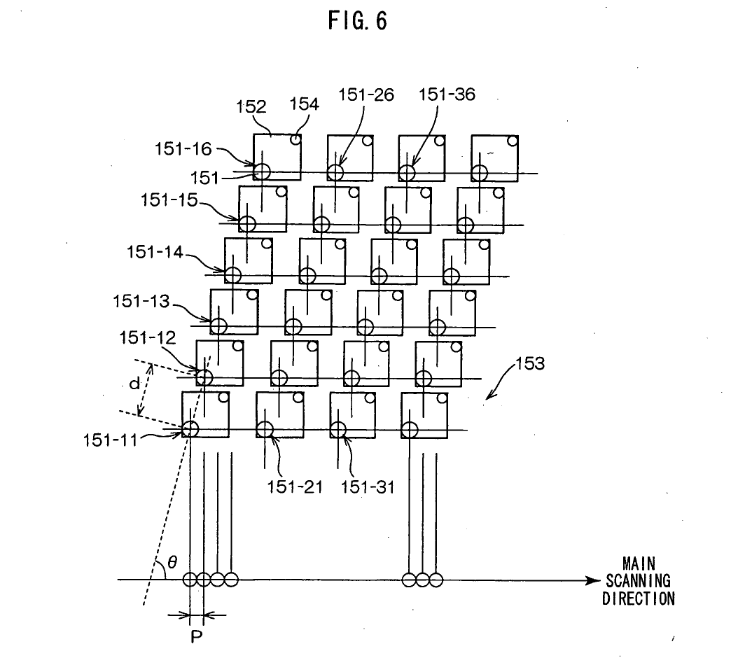

High-density nozzle heads in the exemplary embodiment are achieved by arranging a large number of ink chamber units 153 having the above-described structures in a certain array pattern and in a lattice-like arrangement along a line direction along the main scanning direction and a diagonal row direction not orthogonal to and at a certain angle θ with respect to the main scanning direction as shown in FIG. 6.

In other words, if the plurality of ink chamber units 153 are arranged with a constant pitch d along the direction at the certain angle θ with respect to the main scanning direction, a pitch P of the nozzles projected to be arranged in the main scanning direction is d x cos θ, which may be considered equivalent to the respective nozzles 151 arranged straight with the constant pitch P in the main scanning direction. Achieved with this structure is the high-density nozzle structure including as many as 2400 nozzles per inch (2400 nozzles/inch) in the line of nozzles projected to be arranged in the main scanning direction.

To repeat printing of one line (a line formed of one line of dots or a line formed of a plurality of lines of dots) formed by the above-described main scanning by moving the above-described full-line heads and the paper with respect to each other is defined as sub-scanning.

The direction indicated by the one line (or a longitudinal direction of a belt-shaped area) recorded by the above-described main scanning is referred to as the main scanning direction and the direction in which the above-described sub-scanning is carried out is referred to as the sub-scanning direction. In other words, in the exemplary embodiment, the conveying direction of the recording paper 116 is the sub-scanning direction and the direction orthogonal to the sub-scanning direction is the main scanning direction.

In carrying out the invention, the nozzle arrangement structure is not restricted to the example shown in the drawings. Although the method in which the ink droplet is ejected by deformation of the actuator 158 represented by the piezo element (piezoelectric element) is employed in the exemplary embodiment, the method of jetting the ink is not especially restricted to carry out the invention. As a method that may be employed in place of the piezo-jet method, there are various methods such as a thermal jet method in which a heating element such as a heater heatsink to generate air bubbles to jet an ink droplet with the pressure.

FIG. 7 is a block diagram showing a system configuration of the ink-jet recording apparatus 110. As shown in the drawing, the ink-jet recording apparatus 110 may be broadly divided into a system control unit 200 and a print control unit 180.

The system control unit 200 includes a communication interface 170, a system controller 172, an image storage 174, ROM 175, a motor driver 176, a heater driver 178, and the like.

The communication interface 170 is an interface portion with a host device 10 used by a user to give instructions for printing to the ink-jet recording apparatus 110. As the communication interface 170, a serial interface such as USB (Universal Serial Bus), IEEE1394, Ethernet, and wireless network or a parallel interface such as Centronics. This part may be mounted with buffer memory for speeding up the communication.

The image information sent out from the host device 10 is introduced into the ink-jet recording apparatus 110 via the communication interface 170 and temporarily stored in the image storage 174. The image storage 174 is a storage component for storing the image input via the communication interface 170 and reading and writing of the data are carried out through the system controller 172. The image storage 174 is not restricted to storage formed of a semiconductor element but may be a magnetic medium such as a hard disk.

The system controller 172 is formed of a central processing unit (CPU), their peripheral circuits, and the like, functions as a controller for controlling the entire ink-jet recording apparatus 110 according to a predetermined program, and functions as an arithmetic device for performing various calculations. In other words, the system controller 172 controls respective portions including the communication interface 170, the image storage 174, the motor driver 176, the heater driver 178, and the print control unit 180, controls the communication with the host device 10, controls reading and writing in the image storage 174 and the ROM 175, and generates control signals for controlling a conveying motor 188 and a heater 189. To the print control unit 180, the image information stored in the image storage 174 is sent in addition to the control signal. Moreover, the system controller 172 may generate data of landed position errors, data of dot shapes, and the like from read data that is read in from the printing detecting portion 124.

The ROM 175 stores programs executed by the CPU of the system controller 172 and various data necessary for control. Although the ROM 175 may be a non-rewritable memory component, it is preferable to use a rewritable memory component such as EEPROM in order to update the various data as necessary.

The image storage 174 is used as a temporary storage area of the image information and also used as a development area for the programs and a calculation work area for the CPU.

The motor driver 176 is a driver (a drive circuit) for driving the conveying motor 188 following the instruction from the system controller 172. The heater driver 178 is a driver for driving the heater 189 such as the posterior drying portion 142 according to the instruction from the system controller 172.

The print control unit 180, under control by the system controller 172, functions as a signal processing component for performing various processing, correction, and the like for generating signals for discharge control from the image information transmitted sent from the system control unit 200 and controls discharge driving of the heads 150 based on the generated ink discharge data.

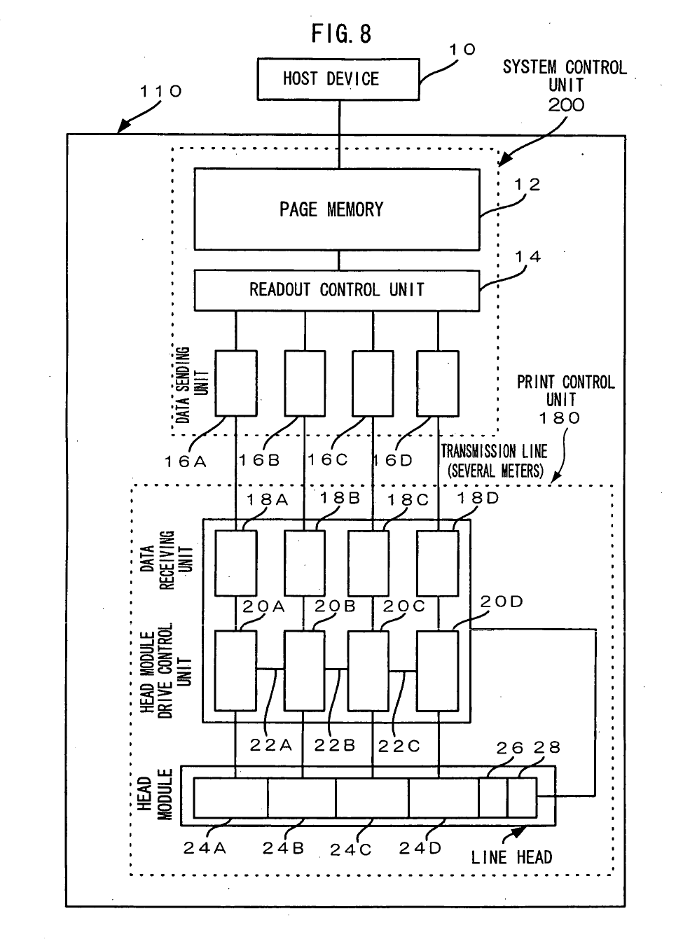

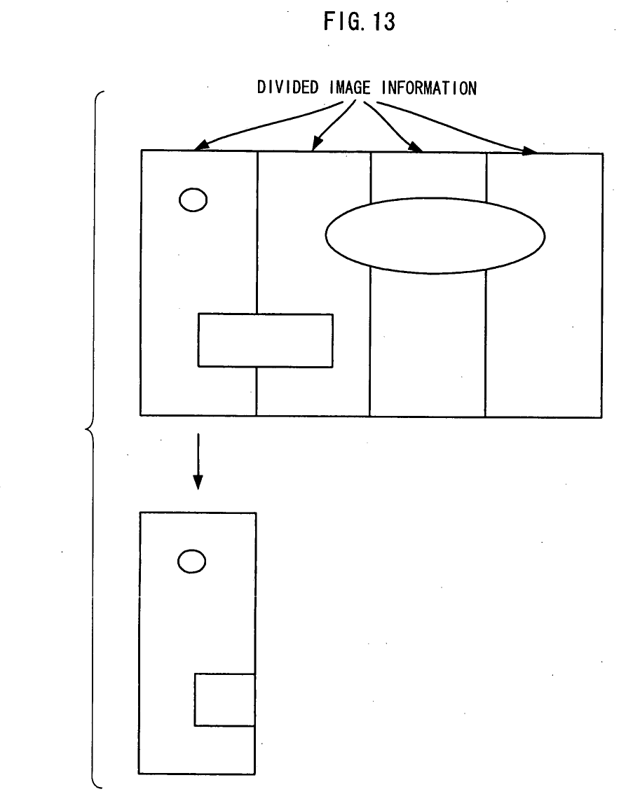

Next, by using FIG. 8, details of the structure related to the exemplary embodiment out of the structure of the above-described ink-jet recording apparatus 110 will be described. The following is description of the structure in a case of dividing the image into four and using pieces of divided image information indicated by the respective four images obtained by the division as shown in FIG. 13.

FIG. 8 shows the above-described host device 10, system control unit 200, and print control unit 180. In the system control unit 200, a page memory 12, a readout control unit 14, and a plurality of (four, in the drawing) data sending units 16A, 16B, 16C, and 16D are shown. In the following description, description common to the portions such as the data sending portions designated by reference numerals that are combinations of a number and letters will be given by using the number only. For example, the data sending portions will be simply referred to as the data sending unit 16.

The data sending unit 16 and a data receiving unit 18 that will be described later are connected by a twisted pair signal line. The divided image information is serialized by the data sending unit 16, converted into a digital signal of 80 MBytes per a second (1 Byte=8 bits)=640 Mbit/sec. or more, and sent to the data receiving unit 18.

The page memory 12 is provided in the image storage 174 shown in FIG. 7 and has a capacity of 2 Gbytes, for example. The readout control unit 14 and the data sending unit 16 are implemented via the CPU or ASIC mounted to the system controller 172.

Next, the print control unit 180 will be described. The print control unit 180 includes a plurality of (four, in the drawing) data receiving units 18A, 18B, 18C, and 18D, a plurality of (four, in the drawing) head module drive control units 20A, 20B, 20C, and 20D, a plurality of (three, in the drawing) transmitting portions 22A, 22B, and 22C, and a plurality of (four, in the drawing) head modules 24A, 24B, 24C, and 24D.

Each head module drive control unit 20 is formed of an independent circuit board and provided in a vicinity of the head module 24. This is for minimizing waveform degradation and the like, because a driving signal generated by the head module drive control unit 20 is an analog signal for driving the piezo element. For this purpose, it is preferable to dispose the head module drive control unit 20 as close as possible to the head module 24 to make wiring between the head module drive control unit 20 and the head module 24 as short as possible.

To put it concretely, it is preferable to dispose the board of the head module drive control unit 20 right above and parallel to the head 112.

On the other hand, the above-described system control unit 200 is mounted with large storage or hard disk, personal computer, and the like in some cases and therefore becomes large in size. Since it is not preferable to dispose the system control unit 200 right above the head 112, the unit 200 is disposed at a distance from the head 112.

The above-described data receiving unit 18 carries out removing noises, correction of errors, and the like of the received divided image information. Since the head module drive control unit 20 is formed of the independent circuit board, the transmitting portion 22 transfers data between boards and is formed of a flexible cable, a flexible printed board, or the like, for example. Because the head module drive control unit 20 is disposed right above the head 112 as described above, the transmitting portion 22 is a several centimeters long at the longest.

Therefore, in the exemplary embodiment, by coping with the displacement immediately before sending the divided image information to the head module 24, a change in the displacement may be responded to and corrected with little delay. As a result, even if the displacement changes quickly, printing may be carried out with high quality without displacement. Moreover, because only an amount of information corresponding to the displacement is transferred, higher-speed printing may be achieved. Since the head module drive control unit 20 and the head module 24 are close to each other and transmission between them is possible via a short signal line represented by the transmitting portion 22, highly reliable and high-speed transmission may be achieved with a simple circuit configuration. Therefore, an inexpensive ink-jet recording apparatus 110 may be provided.

Moreover, because the divided image information corresponding to the displacement need not be transferred by the page memory 12, the system control unit 200 and the print control unit 180 may operate independently of each other, which makes higher-speed processing possible.

In the above-described structure, the system control unit 200 and the print control unit 180 excluding the head modules 24 correspond to the image processing apparatus. As an image forming component, the portions with the head modules 24 correspond to the ink-jet recording apparatus 110 as the image forming apparatus.

In order to use the four pieces of divided image information, there are four data sending units 16, data receiving units 18, head module drive control units 20, and head modules 24, respectively. If the image is divided into N, the number of these portions to be provided becomes N, respectively. The number of transmitting portions 22 is three, because the transmitting portions 22 are communication lines between the four head module drive control units 20. If the number of head module drive control units 20 is N, the number of transmitting portions 22 to be provided is N−1.

The above-described head module 24 form the ink-jet recording apparatus 110. The ink-jet recording apparatus 110 is further provided with a detecting sensor 26 for detecting displacement of a position of the recording medium and areas formed by the head modules 24 from each other and a sending control unit 28 for performing control so that divided image information of an information amount determined by the displacement detected by the detecting sensor 26 is sent from the head module drive control unit 20 corresponding to the head module 24 of one of the adjacent areas to the head module drive control unit 20 corresponding to the head module 24 of the other. The detecting sensor 26 detects the displacement in the width direction of the recording medium and detects edge positions of the recording medium and edge positions of a conveying medium such as the belt, for example. Specifically, the detecting sensor 26 is formed of a photoelectric element (a CCD or a phototransistor) or the like.

A communication line for sending signals for controlling the head module drive control units 20 from the sending control unit 28 is shown in the drawing and the signals are sent to the respective head module drive control units 20.

As shown in FIG. 8, the head modules 24 are provided for the different colors (four colors, K, C, M, Y in the exemplary embodiment) to be formed on the recording medium. The sending control unit 28 controls the respective head module drive control units 20 corresponding to the head modules 24 provided for the respective colors so that the divided image information of the information amount determined by the displacement detected by the detecting sensor 26 is sent from the head module drive control unit 20 corresponding to the head module 24 of one of the adjacent areas to the head module drive control unit 20 corresponding to the head module 24 of the other.

As described above, the number of areas on the recording medium to be formed with the image is four in the exemplary embodiment. Therefore, in the exemplary embodiment, the data sending units 16 in the system control unit 200 are provided to correspond to the four respective head modules 24 to which areas on the recording medium to be formed with the image are allocated in advance. The data sending units 16 send the divided image information indicating the images corresponding to the areas from the image information recorded in the page memory 12.

The data receiving units 18 are provided to correspond to the respective data sending units 16 and receive the divided image information sent by the data sending units 16.

The head module drive control units 20 are provided to correspond to the respective data receiving units 18 and head modules 24 and drive the head modules 24 based on the divided image information received by the data receiving units 18.

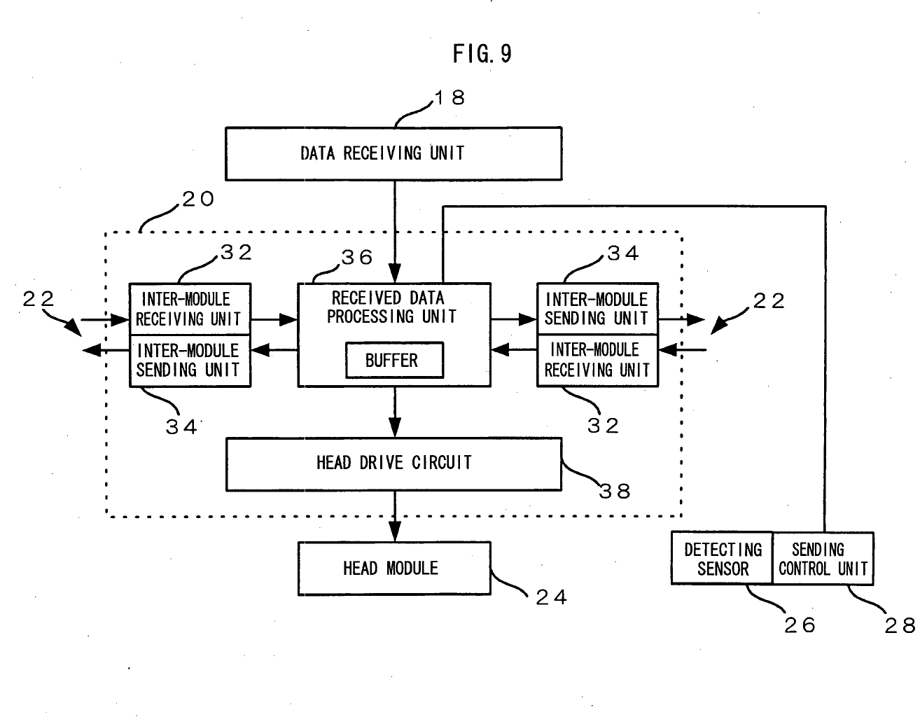

Details of the head module drive control units 20 will be described by using FIG. 9. FIG. 9 shows the head module drive control unit 20, the data receiving unit 18, the head module 24, the detecting sensor 26, and the sending control unit 28.

As shown in the drawing, the head module drive control unit 20 includes a received data processing unit 36, inter-module receiving units 32, the inter-module sending units 34, and a head drive circuit 38.

The received data processing unit 36 has a buffer for retaining the image information received by the data receiving unit 18. In response to the signals received from the sending control unit 28, the received data processing unit 36 sends the divided image information of the information amounts determined by the displacement detected by the detecting sensor 26 from the inter-module sending units 34 to the head module drive control units 20 adjacent to its own head module drive control unit 20.

The received data processing unit 36 receives the divided image information sent by the other head module drive control units 20 with the inter-module receiving units 32.

Based on the divided image information sent and received in the above manner, the head drive circuit 38 generates a drive waveform and outputs it to the head module 24.

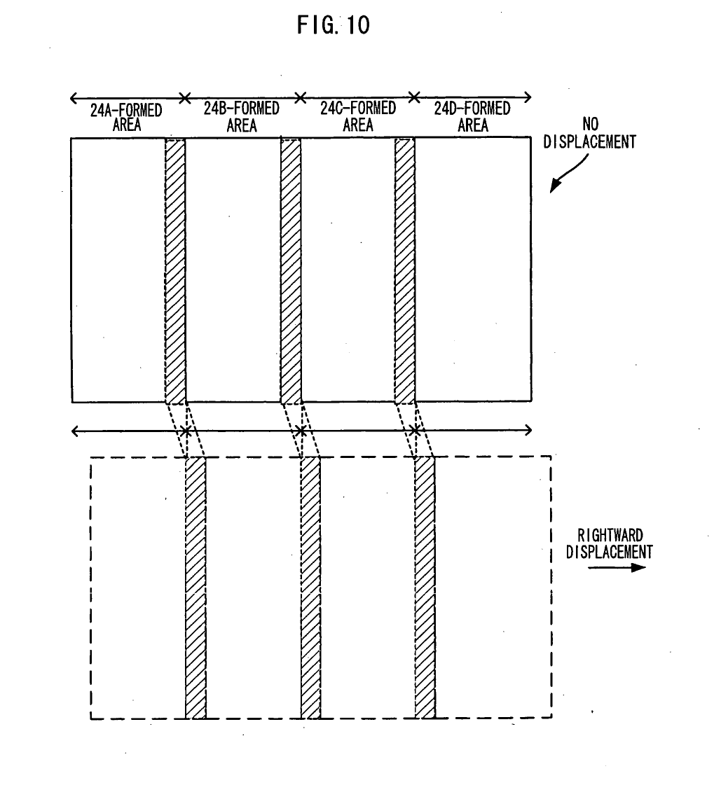

A specific example of the above-described sending of the divided image information of the information amount determined by the displacement detected by the detecting sensor 26 from the inter-module sending unit 34 will be described by using FIG. 10. FIG. 10 shows areas formed by the respective head modules 24 when there is no displacement and areas formed when the recording medium deviates rightward.

In the drawing, the area formed by the head module 24A, for example, is described as a 24A-formed area.

As shown in the drawing, shaded areas are formed by different head modules depending on the displacement and therefore sent to the adjacent head module drive control units 20. The signal for controlling the head module drive control unit 20 from the sending control unit 28 includes a code indicating a displacement direction, i.e., right or left and a signal indicating the amount of information to be sent. Therefore, a code indicating the displacement direction in this case is a code indicating the right.

Because of the displacement, the image is formed outside the range of the “24D-formed area”. FIG. 10 is a drawing for simplifying explanation, the head modules 24 forming the above-described full-line heads may form the image in a wider area than the width of the recording medium and there is no problem in the actual ink-jet recording apparatus 110.

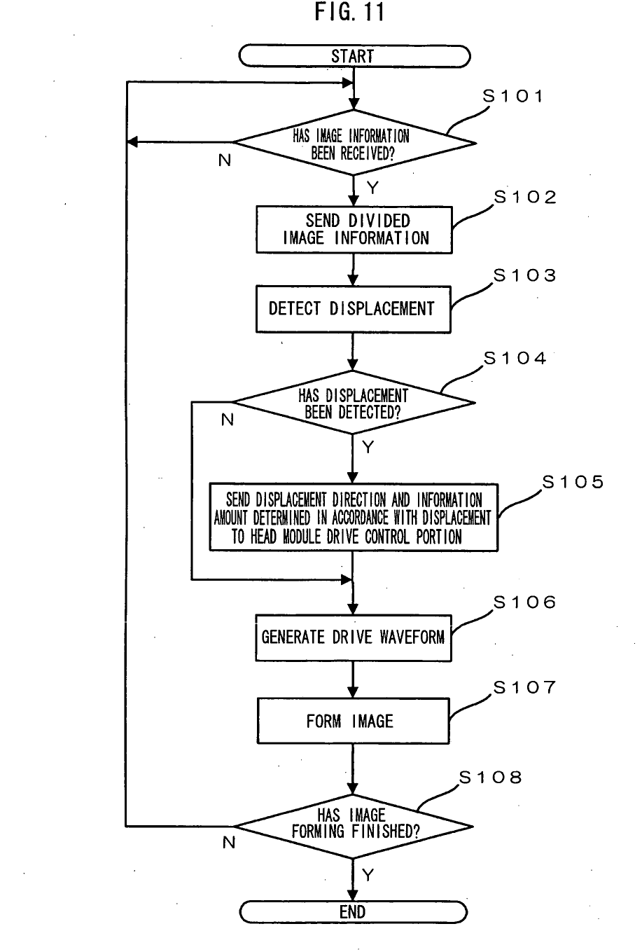

Overall processing performed in the above-described ink-jet recording apparatus 110 according to the exemplary embodiment will be described by using a flowchart in FIG. 11. First, the data sending units 16 provided to correspond to the plurality of head modules 24 to which the areas on the recording medium to be formed with the image are allocated in advance send divided image information indicating images corresponding to the areas from the image information stored in the page memory 12. As a result, in step 101, the data receiving units 18 receive the image information from the data sending units 16. The pieces of image information received here are temporarily stored in the buffers (see FIG. 9). The data sending units 16 send the divided image information in the next step 102 and the detecting sensor 26 detects displacement in step 103.

In step 104, the sending control unit 28 determines whether or not the detecting sensor 26 detected the displacement. In a case of negative determination, the processing goes to step 106. In a case of affirmative determination, on the other hand, the sending control unit 28 carries out control so as to send a displacement direction and an amount of information determined by the displacement to the head module drive control units 20 in step 105. In this way, the respective head module drive control units 20 send and receive the divided image information of the amounts of information determined by the displacement.

The respective head drive circuits 38 generate drive waveforms based on the divided image information in the next step 106 and the head modules 24 form the images based on the drive waveforms in step 107.

In the next step 108, the system controller 172 determines whether or not forming of all the images has finished. In a case of affirmative determination, the processing ends. In a case of negative determination, the processing returns to step 101 again.

In the above-described processing, the image information received in step 101 is sent in amounts of driving by the head module drive control units 20. Therefore, in the above-described flowchart, every time the head modules 24 are driven by the head module drive control units 20, i.e., at every pixel on the printing medium, e.g., at every discharge in a case of the ink-jet heads, the divided image information of the amount of information determined by the displacement detected by the detecting sensor 26 is controlled to be sent from the head module drive control unit 20 corresponding to the head module 24 of one of the adjacent areas to the head module drive control unit 20 corresponding to the head module 24 of the other.

Above-described steps 102 to 106 correspond to the image processing method according to the exemplary embodiment.

Although the ink-jet recording apparatus has been described as an example of the image forming apparatus in the above exemplary embodiment, a range of application of the invention is not restricted to it. Besides the ink-jet type, the invention may be applied to various types of image forming apparatuses such as a thermal transfer recording apparatus including recording heads using thermal elements as recording elements, an LED electrophotographic printer including recording heads using LED elements as recording elements, and a silver halide photographic printer including an LED line exposure head.

In the above-described embodiment, the head modules 24 forming the images in the adjacent areas are not necessarily adjacent to each other in the line heads. For example, in a case of forming the image by using only the head modules 24A and 24C without using the head modules 24B and 24D, the head module 24 adjacent to the head module 24A is the head module 24C.

The above-described processing flow in the flowchart is an example. Needless to say, the order of items of processing may be rearranged, new steps may be added, or unnecessary steps may be eliminated without departing from the gist of the invention.

The invention of a first aspect is an image processing apparatus. The image processing apparatus includes: a storage component that stores image information; sending components provided to correspond to each of a plurality of image forming components to which areas on a recording medium to be formed with an image have been allocated in advance, each sending component sending divided image information indicating an image corresponding to the area from the image information stored in the storage component; receiving components provided to correspond to each of the sending components, each receiving component receiving the divided image information sent by the sending component; driving components provided to correspond to each of the receiving components and each of the image forming components, each driving component driving the corresponding image forming component based on the divided image information received by the receiving component; a detecting component that detects displacement between a position of the recording medium and the areas formed by the image forming components; and a sending control component that controls so that the divided image information of an amount of information defined in accordance to the displacement detected by the detecting component is sent from the driving component corresponding to the image forming component of one of adjacent areas to the driving component corresponding to the other image forming component.

In the invention of the first aspect, the sending component is provided to correspond to each of the plurality of image forming components to which the areas on the recording medium to be formed with the image are allocated in advance. The sending component sends the divided image information indicating the image corresponding to the area from the image information stored in the storage component for storing the image information. The receiving component is provided to correspond to each of the sending components to receive the divided image information sent by the sending component.

The driving component is provided to correspond to each of the receiving components and each of the image forming components to drive the corresponding image forming component based on the divided image information received by the receiving component. The detecting component detects displacement of the position of the recording medium and the areas formed by the image forming components from each other. The sending control component carries out control so that the driving component corresponding to the image forming component of one of the adjacent areas sends the divided image information of the amount of information determined by the displacement detected by the detecting component to the driving component corresponding to the other image forming component.

As described above, the driving component for driving the image forming component sends the image information according to the displacement. Therefore, there is provided the image processing apparatus that may cope with the displacement in the width direction of the recording medium without reducing the transmission speed of the image information from the sending component to the receiving component.

The transmitting control component may carry out control, every time the driving component drives the image forming component, so that the driving component corresponding to the image forming component of one of the adjacent areas sends the divided image information of the amount of information determined by the displacement detected by the detecting component to the driving component corresponding to the other image forming component.

Since the control is carried out every time the driving component drives the image forming component, the changing displacement may be immediately responded to.

The image forming component may be provided for each kind of color formed on the recording medium and the transmitting control component may control the respective driving components corresponding to the image forming components provided for the respective kinds so that the driving component corresponding to the image forming component of one of the adjacent areas sends the divided image information of the amount of information determined by the displacement detected by the detecting component to the driving component corresponding to the other image forming component.

Since the image forming component is provided for each kind of color formed on the recording medium, forming of the image in color may be responded to.

The invention of a second aspect is an image forming apparatus. The image forming apparatus includes: an image processing apparatus; and image forming components, wherein the image processing apparatus includes: a storage component that stores image information; sending components provided to correspond to each of the plurality of image forming components to which areas on a recording medium to be formed with an image have been allocated in advance, each sending component sending divided image information indicating an image corresponding to the area from the image information stored in the storage component; receiving components provided to correspond to each of the sending components, each receiving component receiving the divided image information sent by the sending component; driving components provided to correspond to each of the receiving components and each of the image forming components, each driving component driving the corresponding image forming component based on the divided image information received by the receiving component; a detecting component that detects displacement between a position of the recording medium and the areas formed by the image forming components; and a sending control component that controls so that the divided image information of an amount of information defined in accordance to the displacement detected by the detecting component is sent from the driving component corresponding to the image forming component of one of adjacent areas to the driving component corresponding to the other image forming component.

In the invention of the second aspect, there is provided the image forming apparatus with similar effects to those of the invention of the first aspect.

The invention of a third aspect is an image processing method. The image processing method includes: (a) sending, by sending components provided to correspond to each of a plurality of image forming components to which areas on a recording medium to be formed with an image have been allocated in advance, divided image information indicating an image corresponding to the area from image information stored in a storage component that stores the image information; (b) receiving the divided image information sent in (a) by receiving components provided to correspond to each of the sending components; (c) detecting displacement between a position of the recording medium and the areas formed by the image forming components; (d) controlling so that the divided image information of an amount of information defined in accordance to the displacement detected in (c) is sent from the driving component corresponding to the image forming component of one of adjacent areas to the driving component corresponding to the other image forming component; and (e) driving the corresponding image forming component by the driving component based on the divided image information received by the receiving component and the divided image information sent in (d).

In the invention of the third aspect, since the driving component for driving the image forming component sends the image information according to the displacement, there is provided the image processing method that may cope with the displacement in the width direction of the recording medium without reducing the transmission speed of the image information from the sending component to the receiving component.

According to the invention, there are provided the image processing apparatus, the image forming apparatus, and the image processing method that may cope with the displacement in the width direction of the recording medium without reducing the transmission speed of the image information.

What is claimed is:

1. An image processing apparatus comprising:
a storage component that stores image information;
sending components provided to correspond to each of a plurality of image forming components to which areas on a recording medium to be formed with an image have been allocated in advance, each sending component sending divided image information indicating an image corresponding to the area from the image information stored in the storage component;
receiving components provided to correspond to each of the sending components, each receiving component receiving the divided image information sent by the sending component;
driving components provided to correspond to each of the receiving components and each of the image forming components, each driving component driving the corresponding image forming component based on the divided image information received by the receiving component;
a detecting component that detects displacement between a position of the recording medium and the areas formed by the image forming components; and
a sending control component that controls so that the divided image information of an amount of information defined in accordance to the displacement detected by the detecting component is sent from the driving component corresponding to the image forming component of one of adjacent areas to the driving component corresponding to the other image forming component.

2. The image processing apparatus of claim 1, wherein the sending control component controls, every time the driving component drives the image forming component, so that the divided image information of an amount of information defined in accordance to the displacement detected by the detecting component is sent from the driving component corresponding to the image forming component of one of the adjacent areas to the driving component corresponding to the other image forming component.

3. The image processing apparatus of claim 1, wherein
the image forming components are provided for each color to be formed on the recording medium, and
the sending control component controls the respective driving components corresponding to the image forming components provided for the respective colors so that the divided image information of an amount of information defined in accordance to the displacement detected by the detecting component is sent from the driving component corresponding to the image forming component of one of the adjacent areas to the driving component corresponding to the other image forming component.

4. An image forming apparatus comprising:
an image processing apparatus; and
image forming components, wherein
the image processing apparatus includes:
a storage component that stores image information;
sending components provided to correspond to each of the plurality of image forming components to which areas on a recording medium to be formed with an image have been allocated in advance, each sending component sending divided image information indicating an image corresponding to the area from the image information stored in the storage component;
receiving components provided to correspond to each of the sending components, each receiving component receiving the divided image information sent by the sending component;
driving components provided to correspond to each of the receiving components and each of the image forming components, each driving component driving the corresponding image forming component based on the divided image information received by the receiving component;
a detecting component that detects displacement between a position of the recording medium and the areas formed by the image forming components; and
a sending control component that controls so that the divided image information of an amount of information defined in accordance to the displacement detected by the detecting component is sent from the driving component corresponding to the image forming component of one of adjacent areas to the driving component corresponding to the other image forming component.

5. The image forming apparatus of claim 4, wherein the sending control component controls, every time the driving component drives the image forming component, so that the divided image information of an amount of information defined in accordance to the displacement detected by the detecting component is sent from the driving component corresponding to the image forming component of one of the adjacent areas to the driving component corresponding to the other image forming component.

6. The image forming apparatus of claim 4, wherein
the image forming components are provided for each color formed on the recording medium, and
the sending control component controls the respective driving components corresponding to the image forming components provided for the respective colors so that the divided image information of an amount of information defined in accordance to the displacement detected by the detecting component is sent from the driving component corresponding to the image forming component of one of the adjacent areas to the driving component corresponding to the other image forming component.

7. An image processing method comprising:
(a) sending, by sending components provided to correspond to each of a plurality of image forming components to which areas on a recording medium to be formed with an image have been allocated in advance, divided image information indicating an image corresponding to the area from image information stored in a storage component that stores the image information;
(b) receiving the divided image information sent in (a) by receiving components provided to correspond to each of the sending components;
(c) detecting displacement between a position of the recording medium and the areas formed by the image forming components;
(d) controlling so that the divided image information of an amount of information defined in accordance to the displacement detected in (c) is sent from the driving component corresponding to the image forming component of one of adjacent areas to the driving component corresponding to the other image forming component; and
(e) driving the corresponding image forming component by the driving component based on the divided image information received by the receiving component and the divided image information sent in (d).

8. The image processing method of claim 7, wherein, in (d), controlling is carried out, every time the driving component drives the image forming component, so that the divided image information of an amount of information defined in accordance to the displacement detected in (c) is sent from the driving component corresponding to the image forming component of one of the adjacent areas to the driving component corresponding to the other image forming component.

9. The image processing method of claim 7, wherein
the image forming components are provided for each color formed on the recording medium, and
in (d), the respective driving components corresponding to the image forming components provided for the respective colors are controlled so that the divided image information of an amount of information defined in accordance to the displacement detected in (c) is sent from the driving component corresponding to the image forming component of one of the adjacent areas to the driving component corresponding to the other image forming component.
